(19) United States
(12) Patent Application Publication
(10) Pub. No.: US 2002/0195149 A1
(43) Pub. Date: Dec. 26, 2002

(54) Design of fuel & gas storage tanks to prevent explosion in case of accidental damage and fire

(76) Inventor: Mustafa Demircioglv, San Ramon, CA (US)

Correspondence Address: MUSTAFA DEMIRCIOGLU, APT. # 294, 100 CANYON WOODS LOOP, SAN RAMON, CA, 94583, US

(21) Appl. No.: 10/036,343

(22) Filed: Jan. 4, 2002

Related U.S. Application Data
(60) Provisional application No. 60/299,779, filed on Jun. 21, 2001.

(51) Int. Cl. B64D 37/04

(52) U.S. Cl. 137/574

(57) ABSTRACT

A design of fuel and gas storage tank which prevents explosion in case of accidental damage occurs to the tank and even if the tank caught fire. Design consists of only mechanical attributes but not any other method or process. Adding small volume-less cubical structures (cells) within the tank, establish a physical barriers to prevent explosion. Explosion is a very rapid fuel burning or chain reaction. This design physically slows down the chain reaction while occupying very low volume, and allowing free flow of the fluids inside the tank during normal operations. This design is intended to minimize life lost and damages due to explosion and fuel spills during accidents even if the fuel caught fire. Prevention of explosion during fire provides more time to escape or rescue, and increases the chance of survival. Applications include but not limited to airplanes, utility cars, race cars and boats, fuel tankers, fuel storage tanks and containers.

### BACKGROUND

All fuel storage tanks and containers have potential of accidental damage and fire, subsequently explosion. Explosion causes very heavy damage, lost of life, and also very difficult rescue operations. There are different methods to avoid explosions, however, they are mostly based on isolation of fuels from Oxygen. On the other hand, these methods are not helpful in case of accidental damage occurs to the fuel tank since fuel inside become exposed to ambient, and ready for a spark to explode. In addition of preventative actions against fire, avoiding explosions in case of a fire has many advantages like less damages, more time to escape and saving life, easy to handle fire and rescue operations especially on race car or airplane accidents.

### SUMMARY

Design considers the following criteria; i) for normal operations fuel should not be contaminated chemically or physically, ii) after an accidental damage, since fuel may expose to ambient there should be physical barriers to prevent sudden expose of whole fuel to oxygen in the air, iii) on the other hand, any physical barriers should allow fuel flow within the tank on normal operations. As a result, adding small said volume-less cubical structures (cells) within the tank, establish a physical barriers to serve as preventative measure against explosion. In addition, since design increases tank's inner surface area, more fuel sticks to the surface because of surface tension results in stabilizing more fuel against explosion. Said inner cubical structures (cells) also acts as a heat sink carrying the heat from inside the tank to the outside more efficiently, so decreases fuel temperature to keep fuel more stable condition against explosion. Explosion is a very rapid fuel burning or chain reaction. This design physically slows down the chain reaction while occupying very low volume, and allowing free flow of the fluids inside the tank during normal operations. Said inner cubical structures (cells) could be made of metal or plastic. However, for heat sink usage purpose, said inner cubical structures (cells) must be metal. The sizes of the said inner cubical structures (cells) and said the cell surface hole diameters change according to the chemical and physical state characteristics of the fluid or gas fuel. More the fuel is explosive, smaller the said cubical structures (cells) and the said cell surface hole diameters are. This design attributes based on the idea of establishing said a physical barriers against rapid fuel burning rate in case of fire, while allowing free flow during normal operation. The shapes and sizes of said inner structures (cells) and said cell surface holes could be different than those shown in this document. For further security, plastic covers could be mounted slightly over each said cell surface holes such that on excessive heat or fire these covers melt to seal holes, and capture the fuel inside the said inner cubical structures (cells) during accidents, on the other hand, allowing the fuel flow during normal operations.

### DRAWINGS

FIG. 1 Fuel Tank and Inner Cubical Structures (Cells) Mechanics.

### DESCRIPTION

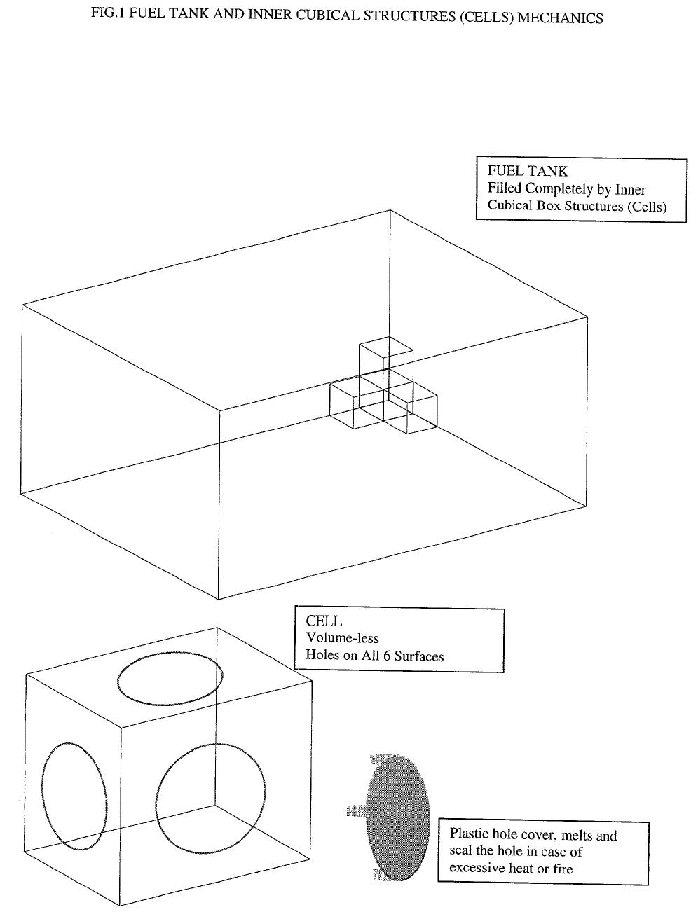

FIG. 1 is a schematic diagram showing a sample rectangular fuel tank, said inner cubical structure (cell), and said hole cover. Inside of tank should be filled by cubical structures (cells) in a way that each said cells connected each other and said outer cells connected to the sides of a tank. Each cell has six holes on each surface. The size of cell and cell surface hole diameter changes according to the application such that for which fuel, the tank will be used. More the fuel is explosive, smaller the said cubical structures (cells) and the said cell surface hole diameters are. This design attributes based on the idea of establishing said a physical barriers against rapid fuel burning rate in case of fire, while allowing free flow during normal operation. Therefore, in order to obtain same results, the shapes and sizes of said inner structures (cells) and said cell surface holes could be different than those shown in this document.

What claimed is:

1. Adding small said volume-less cubical structures (cells) within the tank, establish a physical barriers to prevent explosion. This design physically slows down the fuel burning rate or said chain reaction while occupying very low volume, and allowing free flow of the fluids inside the tank during normal operations.

2. Said inner cubical structures (cells) also acts as a heat sink carrying the heat from inside the tank to the outside more efficiently, so decreases fuel temperature to keep fuel more stable condition against explosion.

3. The sizes of the said inner cubical structures (cells) and said the cell surface hole diameters change according to the chemical and physical state characteristics of the fluid or gas fuel. More the fuel is explosive, smaller the said cubical structures (cells) and the said cell surface hole diameters are.

4. This design attributes based on the idea of establishing said a physical barriers against rapid fuel burning rate in case of fire, while allowing free flow during normal operation. The shapes and sizes of said inner structures (cells) and said cell surface holes don't have to be as shown in this document.
